(19) United States
(12) Patent Application Publication
(10) Pub. No.: US 2003/0136840 A1
(43) Pub. Date: Jul. 24, 2003

(54) Method and system for managing integrated circuit test programs using bar codes

(76) Inventors: Ming Mei Wu, Miaoli (TW); Kuo Hung Shih, Miaoli (TW)

Correspondence Address: BIRCH STEWART KOLASCH & BIRCH, PO BOX 747, FALLS CHURCH, VA, 22040-0747, US

(21) Appl. No.: 10/052,460

(22) Filed: Jan. 23, 2002

(51) Int. Cl. G06K 7/10

(52) U.S. Cl. 235/462.01

(57) ABSTRACT

A method for managing integrated circuit test programs using bar codes. First, a bar code of an integrated circuit is read for obtaining an ID code of the integrated circuit before the integrated circuit is tested. Next, a correlation between a test program and the integrated circuit that is to be tested is automatically searched according to the ID code, so as to read a test program corresponding to the integrated circuit that is to be tested. Then, the corresponding test program is used for testing the integrated circuit. The invention also discloses an IC test system for implementing this method.

### BACKGROUND OF THE INVENTION

1. Field of the Invention

The invention relates to a method and system for managing integrated circuit (IC) test programs, in particular to a method and system for managing IC test programs using bar codes.

2. Description of the Related Art

With the advance in technology, the requirements of integrated circuits increase from day to day. After being designed and tested, integrated circuits with different functions can be applied to various electrical devices to achieve different effects.

Referring to FIG. 1, in general, the design flow for an integrated circuit can be divided into four procedures: a function description procedure, a logic design procedure, a circuit simulation procedure, and a circuit layout procedure. In the function description procedure 11, the functions of the integrated circuit, such as inputs, outputs, and correlations between different inputs and outputs, are defined before the integrated circuit is designed. In the logic design procedure 12, a number of logic units such as AND gates, OR gates, and NAND gates are combined to form the integrated circuit having the functions defined in the function description procedure 11. Since the integrated circuits are always too large and complicated, most design engineers who design integrated circuits, always utilize a computer aided design system for designing and simulating the circuits.

Next, in the circuit simulation procedure 13, the integrated circuit designed by way of the computer aided design system is manufactured to form a semiconductor device, so that the test procedure 15 can be performed therein. During testing, different test programs have to be used for semiconductor devices with different functions. If the circuit simulation test is passed, a circuit layout and simulation procedure 14 is then performed. In the procedure 14, mask patterns required in formal production are designed according to some geometric conditions for mask design,. When the design of mask patterns is finished, a number of factures are also produced for being used in the test procedure 15. Thus, it can be identified that whether or not the designed integrated-circuits can operate according to the prescribed functions when the formal mass production is performed. In testing the number of factures, different test programs have to be used for testing different function descriptions.

In either the tests after the circuit simulation or the tests after the circuit layout and simulation, different test programs have to be loaded into the test machine for testing the integrated circuits having different functions. In the prior arts, an operator who operates the test machine manually selects a program or programs to be loaded. In other words, the operator first finds the corresponding test program(s) according to the production type or product model number of the integrated circuit that is to be tested, and then loads the corresponding test program(s) to the test machine for test.

Although the objective of loading different test programs according to different function descriptions can be inherently achieved by the above-mentioned methods, the application programs might tend to be mistakenly loaded owing to human errors. This can cause various problems, such as unnecessarily increasing the test time and mistaking the integrated circuits that should pass the test for integrated circuits that do not pass the test.

### SUMMARY OF THE INVENTION

In view of the above-mentioned problems, it is therefore an objective of the invention to provide a method and system for managing the test programs for integrated circuits, which can decrease the problems caused by human errors.

Another objective of the invention is to provide a method and system for managing the test programs for integrated circuits, which is advantageous to the automation of the test procedures and the improved efficiency of the test procedures.

To achieve the above-mentioned objectives, the method provided by the invention uses bar codes for managing the IC test programs. Before an integrated circuit is tested, a bar code of the integrated circuit is read so that an ID code of the integrated circuit is obtained. Next, a correlation between the ID code and a test program is automatically searched according to the ID code, so as to load a test program corresponding to the integrated circuit. Then, the test program is used to test the integrated circuit.

In an embodiment of the invention, the content of the bar code, that is, the content of the ID code, may include a product model number or a production type of the integrated circuit.

In another embodiment of the invention, the correlations between the ID codes and the test programs have been set before the test, and have been stored in a table.

In still another embodiment of the invention, the bar code may be attached to a load board or a probe card of the integrated circuit.

The invention also provides an IC test system for implementing the above-mentioned method. The IC test system includes a storage device, a bar code reading device, and a test device. Correlations between ID codes and test programs are stored in the storage device. The bar code reading device reads a bar code attached to an integrated circuit, to obtain an ID code of the integrated circuit. The test device automatically reads a corresponding test program according to the ID code, so as to use this test program for testing the integrated circuit.

According to the invention, since the test machine can automatically load the required test program after the bar code of the integrated circuit is read, problems of test programs caused by loading errors that are induced by human errors can be avoided.

According to the invention, since the test operators do not need to judge and select the test programs manually, the efficiency of the test procedures can be improved. Also, the invention is advantageous to the automation of test procedures.

### BRIEF DESCRIPTION OF THE DRAWINGS

FIG. 1 is a flow chart showing the design and test flows for integrated circuits in the prior art.

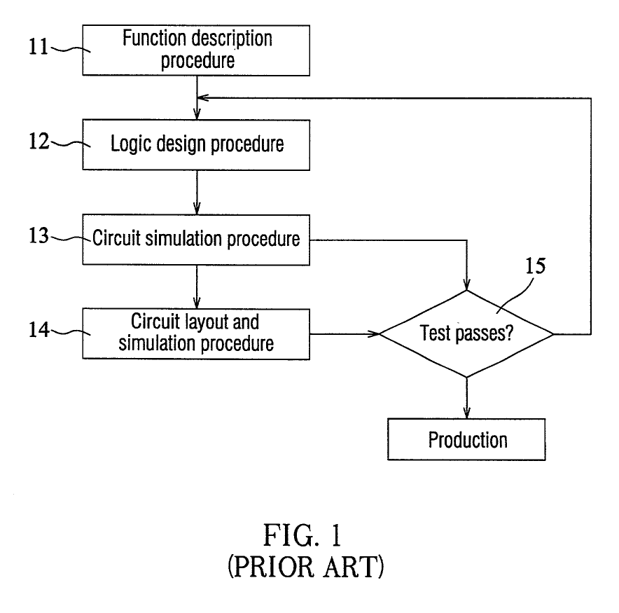

FIG. 2 is a flow chart showing the flow of the method for managing the test programs of integrated circuits using bar codes in accordance with a preferred embodiment of the invention.

FIG. 3 is a schematic illustration showing an example of the correlations among the circuit diagram, test program, and table.

FIG. 4 is a flow chart showing an example of the operation flow of the test system.

FIG. 5 is a block diagram showing the system architecture for managing the test programs for the integrated circuits using bar codes in accordance with a preferred embodiment of the invention.

FIG. 6 is a schematic illustration showing another preferred embodiment of the invention.

### DETAILED DESCRIPTION OF THE PREFERRED EMBODIMENTS

The method and system for managing the test programs for integrated circuits using bar codes in accordance with a preferred embodiment of the invention will be described with reference to the accompanying drawings, wherein the same reference numbers denotes the same elements.

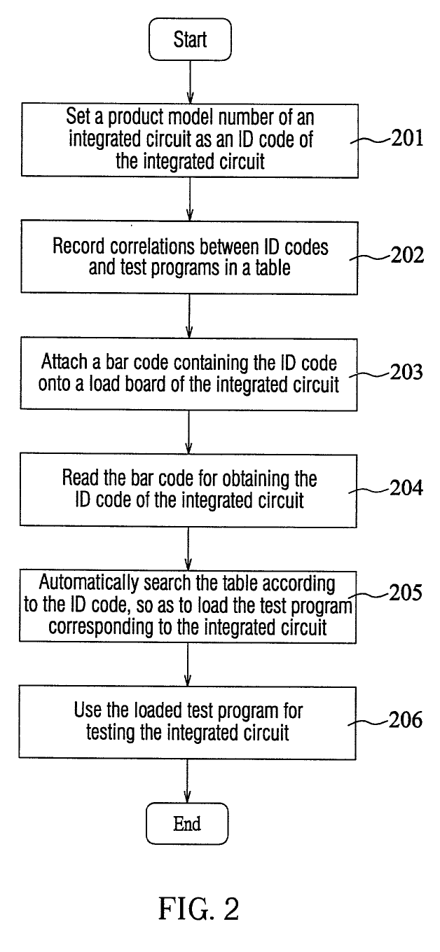

Please refer to FIG. 2. According to the preferred embodiment of the invention, when the design of an integrated circuit is finished, a product model number of the integrated circuit is set as an ID code (step 201). In other words, integrated circuits having the same product model number possesses the same ID code. Next, after the test program for testing the integrated circuit has been written, the correlation between the ID code of the integrated circuit and the test program is set or recorded into a table (step 202).

In step 203, before the integrated circuit is tested, the ID code of the integrated circuit is made into a bar code and is attached to a load board or a probe card of the integrated circuit. At this time, the preparation works before the integrated circuit is tested are finished.

According to this embodiment, when testing the integrated circuit, the test engineer executes a test program at first. This test program waits for the input of the bar code and automatically executes a test procedure after the bar code is received. After executing this test program, the test engineer utilizes a bar code reading device for reading the bar code, so as to obtain the ID code of the integrated circuit (step 204). After the bar code is read, the test system may search the table for loading a test program corresponding to the integrated circuit (step 205). Then, the loaded test program is used to test the integrated circuit (step 206).

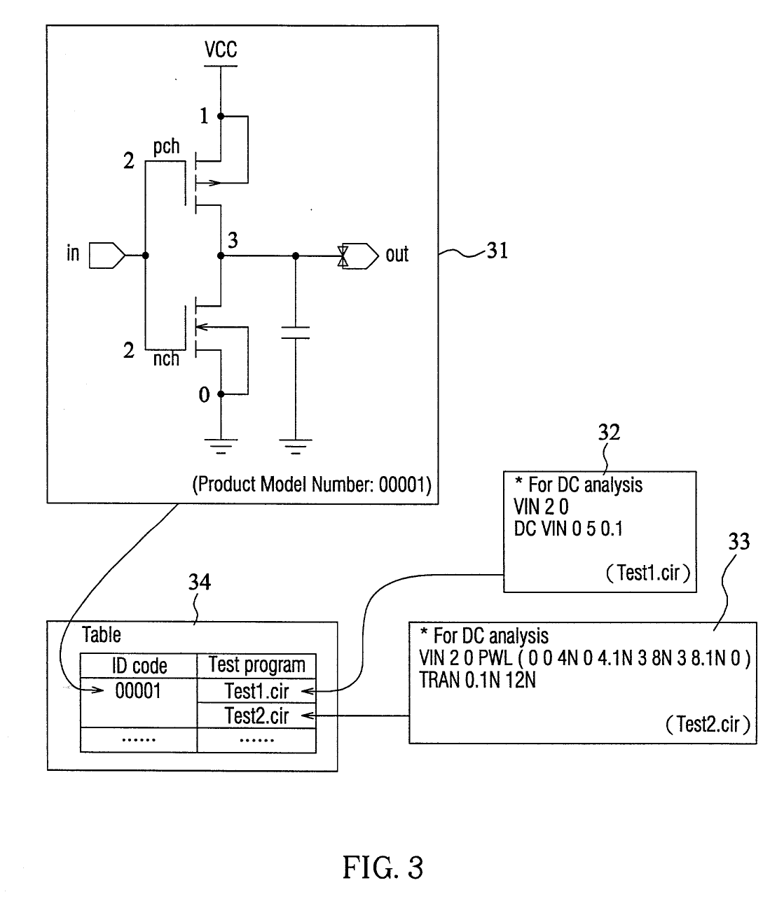

For example, referring to FIG. 3, when a circuit design engineer has designed a CMOS inverter circuit 31, he or she can write two test programs 32 and 33 for the inverter circuit 31. The test program 32 is used to gradually apply a DC voltage, ranging from 0 to 5V, to terminals 2 (the gates of two transistors) in the inverter circuit 31 with an increment of 0.1 V. The test program 33 changes the voltage applied to the terminals 2 in the inverter circuit 31 to a varying voltage. The varying voltage is at 0 V at the beginning, jumped up to 3 V at 4.1 nanoseconds, kept at 3 V for 5 nanoseconds, and back to 0 V at 9.1 nanoseconds at last.

After finishing the test programs 32 and 33, the design engineer may set or record the correlations between the test programs 32, 33 and the inverter circuit 31 into a table 34. In the table 34, the product model number is the ID code of the inverter circuit 31.

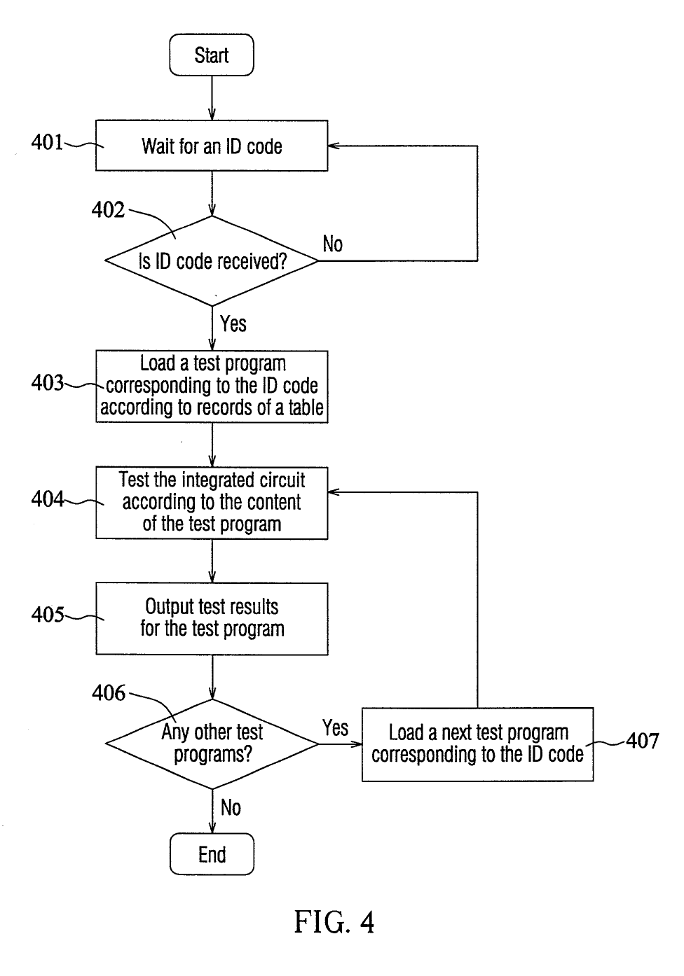

The CMOS inverter circuit 31 designed by the circuit design engineer is manufactured into a real integrated circuit that is to be tested by the test engineer. In this embodiment, the test engineer executes a main test program in the test system, and the flow of this main test program is shown in FIG. 4. At first, the test system waits for the ID code of the CMOS inverter circuit 31 input by the test engineer (step 401). That is, the test system waits for the test engineer to use a bar code reading device for reading the bar code on the load board. When the ID code is obtained (step 402), the test system automatically searches the table for a test program corresponding to this ID code (step 403).

After loading the program Test1.cir, the test system uses this program to test the response when the voltage of the CMOS inverter circuit 31 gradually increases (step 404), and outputs the test results (step 405). Since there are two test programs Test1.cir and Test2.cir corresponding to the CMOS inverter circuit 31, the test system judges that there is still another test program (step 406) after the test done by the program Test1.cir is finished. Then, the program Test2.cir is loaded (step 407) to test the response when the CMOS inverter circuit 31 receives pulse voltages.

As is well known to those skilled in the art, various equivalent changes or modifications may be easily made to the flow shown in FIG. 4. For example, the output results of each test program may be temporarily stored, and then output together with other output results after all test programs are finished.

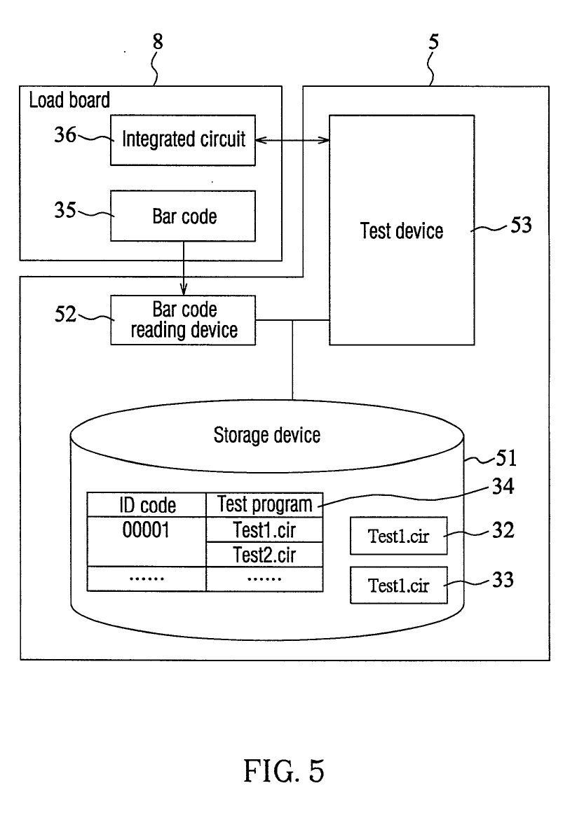

Referring to FIG. 5, in order to implement the above-mentioned flow, an IC test system 5 in accordance with a preferred embodiment of the invention includes a storage device 51, a bar code reading device 52, and a test device 53. The storage device 51 can be any recording device that can store the electromagnetic data. For example, the recording device may be a hard disk driver or a rewritable optical disk player. The bar code reading device 52 can be any device capable of reading a bar code 35 attached to a load board 8. The test device 53 can be any device capable of testing an integrated circuit 36.

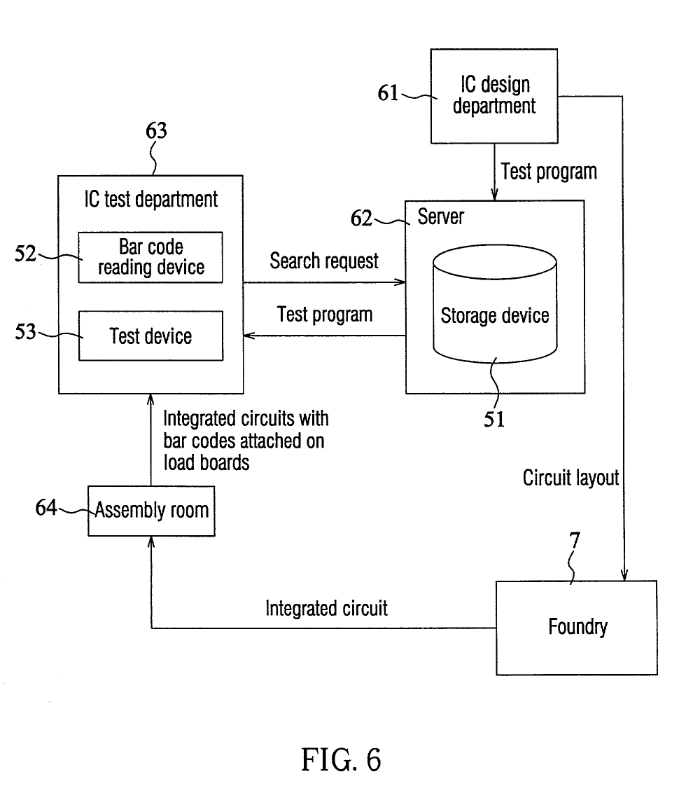

Please refer to FIG. 6. According to another embodiment of the invention, the storage device 51 can be provided in a server 62, while the bar code reading device 52 and the test device 53 can be provided in an IC test department 63. In addition, a communication network is provided for connection among an IC design department 61, the server 62, and the IC test department 63. In FIG. 6, the dashed lines together with the arrows indicate the signal transmissions, while the solid lines together with the arrows indicate the actual material flow.

After the IC design department 61 has finished the design of an integrated circuit, the test programs are transferred to the server 62 and the circuit layouts are transferred to a foundry 7. Thus, the real integrated circuit can be manufactured according to the circuit layouts. In the IC design department 61, the ID codes of the circuit corresponding to the test programs may be set into the server 62. The ID codes are also transferred to the foundry 7.

After the foundry 7 has manufactured the integrated circuit, the integrated circuit is placed in an assembly room 64. In the assembly room 64, the integrated circuit is place on a load board onto which a bar code is attached, and is transferred to the IC test department 63.

When testing an integrated circuit, the IC test department 63 firstly uses the bar code reading device 52 to read the bar code for obtaining the ID code of the integrated circuit. Then, the test device 53 sends a search request of the test program to the server 62 for obtaining the test program corresponding to the ID code. After the test program transferred by the server is obtained, the test device 53 can start testing the integrated circuit.

According to the above-mentioned flow, the test flow can be automated so as to decrease human errors. In addition, the managers in the assembly room 64 can manage the integrated circuits transferred into and out of the assembly room 64 according to the bar code on the load board. In other words, the managing flows among the IC design department 61, IC test department 63, and assembly room 64 can be further integrated by the method of the invention for managing the test programs using bar codes, thereby improving the whole operation efficiency.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

What is claimed is:

1. A method for managing integrated circuit test programs using bar codes, comprising:
reading a bar code of an integrated circuit to obtain an ID code of the integrated circuit;
automatically searching a correlation between the ID code and a test program according to the ID code, for loading the test program; and
using the test program for testing the integrated circuit.

2. The method according to claim 1, farther comprising:
assigning the ID code to the integrated circuit.

3. The method according to claim 1, further comprising:
recording the correlation between the ID code and the test program before testing the integrated circuit.

4. The method according to claim 1, wherein the ID code comprises a product model number of the integrated circuit.

5. The method according to claim 1, wherein the ID code comprises a product type of the integrated circuit.

6. The method according to claim 1, wherein the bar code is attached to a load board of the integrated circuit.

7. The method according to claim 1, wherein the bar code is attached to a probe card of the integrated circuit.

8. An integrated circuit test system, comprising:
a storage device for storing a correlation between an ID code and a test program;
a bar code reading device for reading a bar code of an integrated circuit so as to obtain the ID code of the integrated circuit; and
a test device for automatically reading the test program according to the ID code, and for testing the integrated circuit using the test program.

9. The integrated circuit test system according to claim 8, wherein the ID code comprises a product model number of the integrated circuit.

10. The integrated circuit test system according to claim 8, wherein the ID code comprises a production type of the integrated circuit.

11. The integrated circuit test system according to claim 8, wherein the bar code is attached to a load board of the integrated circuit.

12. The integrated circuit test system according to claim 8, wherein the bar code is attached to a probe card of the integrated circuit.

13. A method for managing integrated circuit test programs using bar codes, comprising:
assigning an ID code to an integrated circuit;
recording a correlation between the ID code and a test program in a table, attaching a bar code to the integrated circuit, the data of the bar code including the ID code;
reading the bar code for obtaining the ID code of the integrated circuit;
automatically searching the table for loading the test program according to the ID code; and
using the test program for testing the integrated circuit.

14. The method according to claim 13, wherein the ID code comprises a product model number of the integrated circuit.

15. The method according to claim 13, wherein the ID code comprising a production type of the integrated circuit.

16. The method according to claim 13, wherein the bar code is attached to a load board of the integrated circuit.

17. The method according to claim 13, wherein the bar code is attached to a probe card of the integrated circuit.
